(19) United States
(12) Patent Application Publication
(10) Pub. No.: US 2018/0117456 A1
(43) Pub. Date: May 3, 2018

(54) Teaching Tile Set with Pictorial Characters Thereon

(71) Applicant: Wen Hao Liao, Taipei City (TW)

(72) Inventor: Wen Hao Liao, Taipei City (TW)

(21) Appl. No.: 15/801,504

(22) Filed: Nov. 2, 2017

(30) Foreign Application Priority Data
Nov. 3, 2016 (TW) 105135711

(51) Int. Cl. A63F 3/04; G09B 1/16; A63F 3/00

(52) U.S. Cl. CPC A63F 3/0402; G09B 1/16; A63F 2003/00842; A63F 3/00697; A63F 2003/041; A63F 3/0423

(57) ABSTRACT

A teaching tile set with pictorial characters thereon includes a set of tiles with pictorial characters thereon and a first Chinese character tree diagram board. The first Chinese character tree diagram board has multiple first pictorial characters thereon and multiple derived relationships among the multiple first pictorial characters, and each first pictorial character is mapped to the pictorial character on one tile of the set of tiles. The pictorial characters on the set of tiles provide modern characters that pictorize Chinese characters to simulate initial forms of ancient Chinese characters. By collaborating the teaching tile set with group games to learn derived relationships of Chinese characters, recognize Chinese characters with the same root, and distinguish components of Chinese characters, the goal of facilitating learners' understanding of the way of composing Chinese characters can be realized.

### REPRESENTATIVE FIGURE

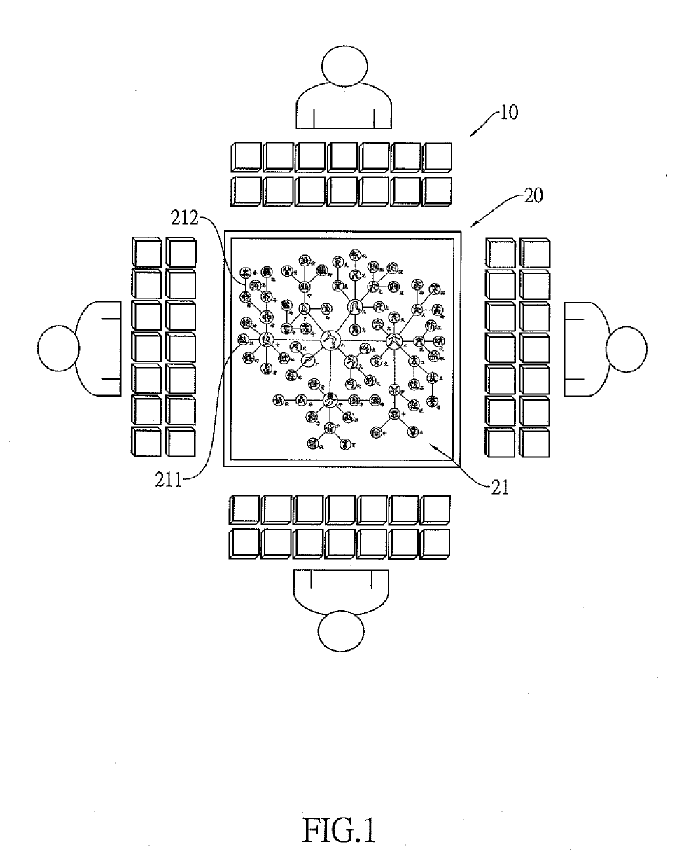

(1) FIG. 1 is specified as the representative figure.

(2) Brief description of the representative figure:
10 A set of tiles
20 First Chinese character tree diagram board
21 First Chinese tree diagram
211 First pictorial character
212 First derived link

### DESCRIPTION OF THE INVENTION

### Field of the Invention

The present invention relates to a teaching tool and, more particularly, to a teaching tile set with pictorial characters thereon.

### Prior Art

Current Chinese character learning methods are mainly based on modern Chinese characters and include the radical-based approach, word-in-word approach, component-based approach, pinyin approach and the like. As changed to clerical scripts after Qin and Han dynasties, ancient Chinese characters taking the pictorial forms resembling the objects to be represented are too heavily distorted to maintain the original ideas of creating them for the purpose of intuitive understanding. Since most radicals and components of modern Chinese characters no longer resemble the corresponding objects to be represented, modern Chinese characters developed based on the clerical scripts fail to deliver the derived relationship between them and corresponding word meaning, which is meaningful for quick and interesting Chinese learning instead of falling into mindless and mechanical recitation.

Information provided by one type of current Chinese character search systems includes basic information associated with radicals, semantics, phonemes, coinage, sentence-making, and the like, which have disadvantages of being fragmentary, cluttered and unsystematic. As disclosed in Taiwan Patent No. 1448997, entitled “Word-spelling learning card and teaching tool with the same” (hereinafter referred to as “the conventional technique”), the word-spelling learning card includes a plurality of head-cards, body-cards, and tail-cards, a complete pattern or figure of an object can be assembled by selecting one of the head-cards, one of the body-cards, and one of the tail-cards. Each head-card has a prefix composed of English alphabet letters, the body-card has a main body of an English word composed of English alphabet letters, and the tail-card has a suffix composed of English alphabet letters. The head-card, body-card, tail-card are laterally arranged in front, middle and rear in sequence so that the prefix, the main body of the word, and the suffix will compose a word. The teaching tool includes the word-spelling learning card and a carrier, and the carrier includes a plurality of board bodies for different type cards of the word-spelling learning cards to combine together according to their types. The word-spelling learning cards can be taken from the carrier when in use.

As can be seen from the foregoing description, current Chinese character learning methods do not go beyond the scope of the radical-based approach, the word-in-word approach, the component-based approach, and the pinyin approach, which concern no derived relationship between Chinese characters and their corresponding word meanings and leave learners with the way of studying Chinese characters relying upon mechanical recitation. Besides, as an aid for study, the current Chinese character search systems provide information in a less organized and systematic way, leading to inefficient learning of Chinese characters. Although different word-spelling learning cards in the conventional technique can compose words and figures to entertain learners for a short while, for learning Chinese characters in depth, the conventional technique fails to teach original meanings of Chinese characters, the derived relationship among Chinese characters and the initial idea of intuitive understanding when creating Chinese characters. After the entertaining effect of the conventional technique fades away, what's left to learn Chinese characters may inevitably turn to the mechanical recitation.

### SUMMARY OF THE INVENTION

An objective of the present invention is to provide a teaching tile set with pictorial characters thereon, which is designed according to word meanings and components of Chinese characters, allowing learners to understand derived relationships among Chinese characters through group games, recognize related Chinese characters in a same character family, distinguish direct relatives and collateral relatives of components in Chinese characters for learners' understanding of the way of composing Chinese characters.

To achieve the foregoing objective, the teaching tile set with pictorial characters thereon includes a set of tiles with pictorial characters thereon and a first Chinese character tree diagram board.

Each tile of the set of tiles has a pictorial character formed thereon.

The first Chinese character tree diagram board has a first Chinese character tree diagram thereon. The first Chinese character tree diagram has multiple first pictorial characters thereon and multiple derived relationships among the multiple first pictorial characters. Each first pictorial character on the first Chinese character tree diagram board is mapped to the pictorial character of one tile in the set of tiles.

From the foregoing description, the pictorial character on each tile of the set of tiles can correspond to one of the multiple first pictorial characters on the first Chinese character tree diagram board, and there are multiple derived relationships among the multiple first pictorial characters on the first Chinese character tree diagram board. There are many advantages for using those pictorial characters. Firstly, the advantages include intuitive understanding of word meanings from the pictorial forms for learners to quickly memorize and understand the initial idea upon composing Chinese characters. Secondly, derived relationships are built among pictorial characters, and the Chinese character tree diagram is used as a tool to integrate derived relationships of the pictorial characters. Through all these advantages, Chinese characters can be constructed as systematic pictorial characters, which are impossible for traditional Chinese character systems to achieve. By way of combining with self-defined group games, the teaching tile set can raise the interest and effectiveness in learning derived relationships of Chinese characters, recognizing related Chinese characters in a same character family, and distinguishing components in Chinese characters, thereby assisting learners in understanding the way of composing Chinese characters.

### DETAILED DESCRIPTION OF THE PREFERRED EMBODIMENTS

With reference to FIG. 1, a teaching tile set with pictorial characters thereon in accordance with the present invention includes a set of tiles 10 with pictorial characters thereon and a first Chinese character tree diagram board 20. The first Chinese character tree diagram board 20 has a first Chinese character tree diagram 21 thereon. The first Chinese character tree diagram 21 has multiple first pictorial characters 211 thereon and multiple derived relationships among the multiple first pictorial characters 211. In the present embodiment, a first derived link 212 is connected between each two corresponding first pictorial characters 211 on the first Chinese character tree diagram board 20.

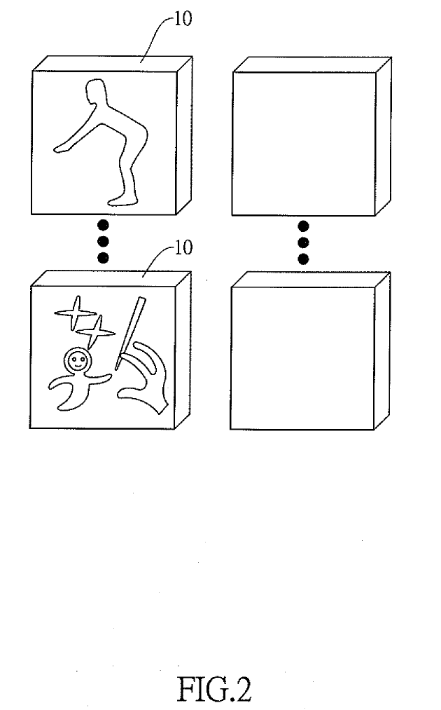

With reference to FIGS. 1 and 2, each tile of the set of tiles 10 has a pictorial character formed thereon and each first pictorial character 211 on the first Chinese character tree diagram board 20 is mapped to the pictorial character of one tile in the set of tiles 10. In the present embodiment, the set of tiles 10 includes multiple tiles with pictorial characters thereon similar to mahjong tiles, and each tile has a front surface and a rear surface with a corresponding pictorial character formed on the front surface of the tile.

In the present embodiment, the pictorial characters on the set of tiles provide a modern character system that pictorizes Chinese characters to simulate initial forms of ancient Chinese characters. It is stressed that basic parts of Chinese characters are termed as components traditionally, and each component of Chinese characters is originally a hieroglyph having a specific form and meaning. Hence, in the present embodiment each component of Chinese characters is converted into an elementary pictorial symbol, which is configured as a pictorial element. As Chinese characters are composed of the components, all the elementary pictorial elements are generated prior to creation of the pictorial characters. Then, the elementary pictorial elements are selectively combined to form corresponding pictorial characters.

Through the present embodiment, Chinese characters can be constructed as systematic pictorial characters, which are impossible to be achieved by conventional Chinese character systems. Learning Chinese characters in collaboration with self-defined group game can raise the interest and effectiveness in learning derived relationships of Chinese characters, recognizing Chinese characters with the same root, and distinguishing components of Chinese characters (direct relatives and collateral relatives), thereby realizing the goal of facilitating learners' understanding of the way of composing Chinese characters.

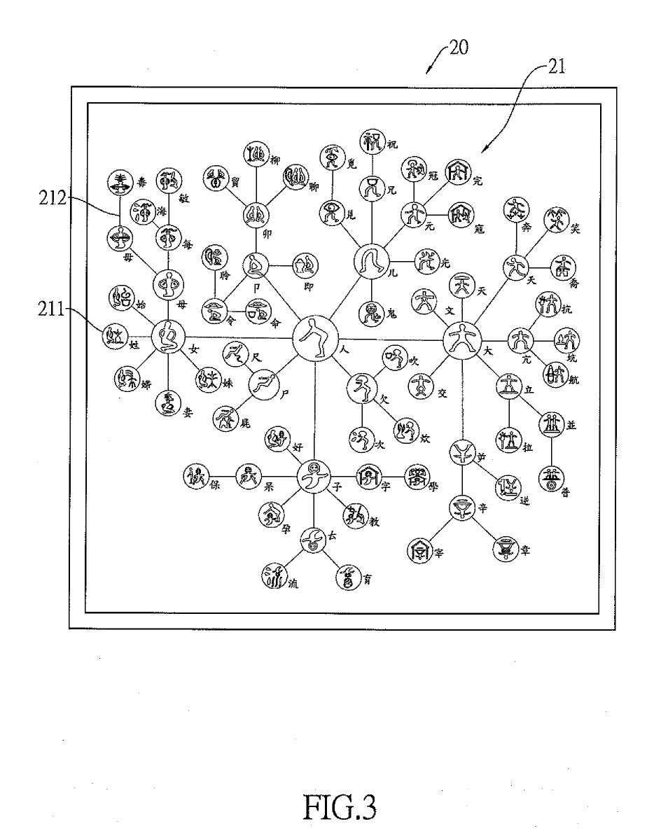

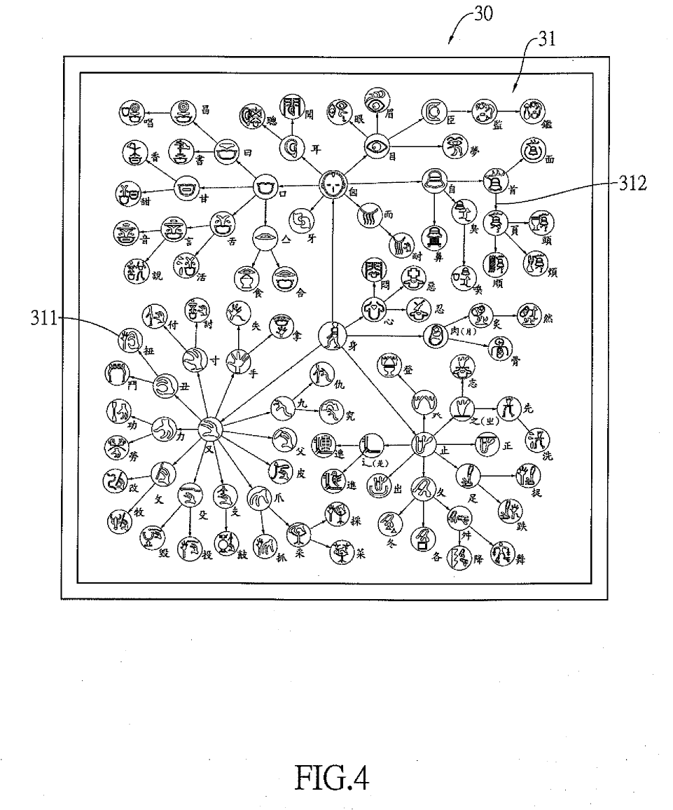

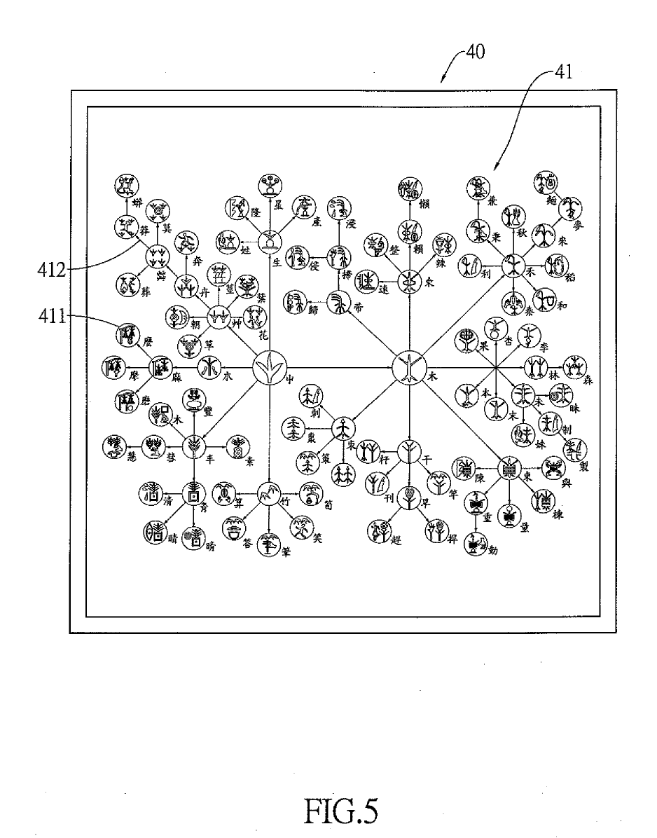

With reference to FIGS. 1 and 3, to explain how learners play a game, before the game starts, all learners participating in the game must use the first Chinese character tree diagram boards 20 along with the set of tiles to play. Moreover, with reference to FIGS. 4 and 5, the teaching tile set further includes a second Chinese character tree diagram board 30 and a third Chinese character tree diagram board 40 structurally similar to the first Chinese character tree diagram 20. The second Chinese character tree diagram board 30 has a second Chinese character tree diagram 31 thereon. The second Chinese character tree diagram 31 has multiple second pictorial characters 311 thereon and multiple derived relationships among the multiple second pictorial characters 311. Each second pictorial character 311 on the second Chinese character tree diagram board 30 is mapped to the pictorial character of one tile in the set of tiles 10. A second derived link 312 is connected between each two corresponding second pictorial characters 311 on the second Chinese character tree diagram board 30. The third Chinese character tree diagram 41 has multiple third pictorial characters 411 thereon and multiple derived relationships among the multiple third pictorial characters 411. Each third pictorial character 411 on the third Chinese character tree diagram board 40 is mapped to the pictorial character of one tile in the set of tiles 10. A third derived link 412 is connected between each two corresponding third pictorial characters 411 on the third Chinese character tree diagram board 40.

In the present embodiment, the first Chinese character tree diagram board 20 is a Chinese character tree diagram board involved with the word “human” in Chinese with a pictorial form [symbol] , which records the derived first pictorial characters 211 associated with human and the first derived links 212. The second Chinese character tree diagram board 30 is a Chinese character tree diagram board involved with the word “body” in Chinese, which records the derived second pictorial characters 311 associated with human organs and the second derived links 312. Hence, the first Chinese character tree diagram board 20 and the second Chinese character tree diagram board 30 may be associated with each other. Furthermore, the third Chinese character tree diagram board 40 may not be associated with the first Chinese character tree diagram board 20 and the second Chinese character tree diagram board 30. In the present embodiment, the third Chinese character tree diagram board 40 may be associated with other words, which are not associated with the word “human” of the first Chinese character tree diagram board 20 and the word “body” of the second Chinese character tree diagram board 30. The third Chinese character tree diagram board 40 may be involved with, for instance, the word “ [symbol] ” in Chinese and records the derived third pictorial characters 411 and the third derived links 412. Pictorial characters on the multiple sets of tiles 10 respectively correspond to the multiple first pictorial characters 211, the multiple second pictorial characters 311 and the multiple third pictorial characters 411.

Rules of a Chinese character tree growth game are given as an example as follows. First of all, the multiple sets of tiles are evenly distributed to all learners. Then, the learners sequentially place corresponding tiles they have on any of the first, second and third Chinese character tree diagram boards 20, 30, 40 according to a growth sequence (i.e. derived sequence). Given a tree growth game using the first Chinese character tree diagram board 20 as an example, the teaching tools are one of the Chinese character tree diagram boards associated, with the word “human” and a corresponding set of tiles. After the game begins, the learner who has the tile with the pictorial character [symbol] (human) places the tile on a center of the Chinese character tree diagram board. Subsequent learners must play tiles based on the growth sequence of the Chinese character tree. If there is no match, the current learner needs to selectively hold up one of the tiles in hand and it goes the turn of the next learner. After the game is over, the learner with the least tiles held up wins.

Major rules of the Chinese character tree growth game must follow the growth sequence indicated on the Chinese character tree diagram board to sequentially place corresponding tiles. The growth sequence of the Chinese character tree is also named as the derived sequence. In the case of the Chinese character tree diagram board associated with the word “human” as shown in FIG. 3, the word [symbol] derives [symbol] , [symbol] , [symbol] , and the like, the word [symbol] further derives [symbol] , [symbol] , and the like, and the word [symbol] further derives [symbol] and [symbol] .

A Chinese character family collection game is designed for learners to recognize all Chinese characters in a same character family. The teaching tools involved for the Chinese character family collection game are one set of tiles with pictorial characters. The tile-drawing rule of the game is identical to that of playing mahjong. Firstly, the tiles are shuffled and stacked for each learner to sequentially draw the tiles. The rules for the game is that an initiating learner who has multiple tiles with the pictorial characters pertinent to a same character family play the multiple tiles and simultaneously speak out the name of certain character family for collection, and subsequent players must follow to play their tiles pertinent to the character family. The learner who plays most tiles pertinent to the character family in the current round has the right to pick another character family in the next round. In the end the learner who finishes all the tiles in hand first wins the game.

For example, if the initiating learner speaks out the character family pertinent to the word [symbol] (female), then all the tiles with the pictorial characters in the character family [symbol] can be played and include [symbol] , [symbol] , [symbol] , [symbol] , [symbol] and the like. Similarly, if the initiating learner speaks out the character family pertinent to the word [symbol] , the rest of the learners who have the tiles with the kneeling figure can play the associating tiles. If any learner has no tile pertinent to the designated character family, the learner must continuously draw the tiles stacked until a tile pertinent to the character family shows up or three tiles in a row not pertinent to the character family have been drawn.

A Chinese character blood relative game is designed for learners to distinguish direct relatives and collateral relatives of components of Chinese characters. The teaching tools involved for the Chinese character family collection game are one set of tiles with pictorial characters. The tile-drawing rule of the game is identical to that of playing mahjong. Firstly, the tiles are shuffled and stacked as a tile wall for each learner to sequentially draw the tiles. The remaining tiles of the tile wall serve for supplementary tile drawing. The rules for playing the game are that the initiating learner draws a tile from the tile wall and selectively discards a tile of the learner to the pool. In the end whoever has any adjacent two of the tiles in hand that are blood relatives wins the game.

The blood relatives can be divided into direct relatives and collateral relatives. The basis for determination of blood relatives is a direct derived relationship between the pictorial characters of two tiles. For example, the two tiles with the pictorial characters [symbol] and [symbol] pertain to direct relatives. If there is no direct derived relationship, two tiles with pictorial characters with an identical character component, such as [symbol] and [symbol] , may be considered as collateral relatives.

### BRIEF DESCRIPTION OF THE DRAWINGS

FIG. 1 is an operational schematic diagram of a teaching tile set with pictorial characters thereon in accordance with the present invention;

FIG. 2 is a schematic perspective view of some teaching tiles of the teaching tile set in FIG. 1;

FIG. 3 is an enlarged schematic diagram of a first Chinese character tree-mapping board of the teaching tile set in FIG. 1;

FIG. 4 is an enlarged schematic diagram of a second Chinese character tree-mapping board further included in the teaching tile set in FIG. 1; and

FIG. 5 is an enlarged schematic diagram of a third Chinese character tree-mapping board further included in the teaching tile set in FIG. 1.

### DESCRIPTION OF THE REFERENCE NUMERALS OF MAJOR COMPONENTS

10 A set of tiles
20 First Chinese character tree diagram board
21 First Chinese tree diagram
211 First pictorial character
212 First derived link
30 Second Chinese character tree diagram board
31 Second Chinese tree diagram
311 Second pictorial character
312 Second derived link
40 Third Chinese character tree diagram board
41 Third Chinese tree diagram
411 Third pictorial character
412 Third derived link

1. A teaching tile set with pictorial characters thereon, comprising:
a set of tiles with pictorial characters thereon, each tile of the set of tiles having a pictorial character formed thereon; and
a first Chinese character tree diagram board having a first Chinese character tree diagram thereon, wherein the first Chinese character tree diagram has multiple first pictorial characters thereon and multiple derived relationships among the multiple first pictorial characters, and each first pictorial character on the first Chinese character tree diagram board is mapped to the pictorial character of one tile in the set of tiles.

2. The teaching tile set as claimed in claim 1, further comprising a second Chinese character tree diagram board, wherein the second Chinese character tree diagram board has a second Chinese character tree diagram with multiple second pictorial characters thereon and multiple derived relationships among the multiple second pictorial characters, each second pictorial character on the second Chinese character tree diagram board is mapped to the pictorial character of one tile in the set of tiles, and the first Chinese character tree diagram board and the second character tree diagram board are associated with each other.

3. The teaching tile set as claimed in claim 1, further comprising a third Chinese character tree diagram board, wherein the third Chinese character tree diagram board has a third Chinese character tree diagram with multiple third pictorial characters thereon and multiple derived relationships among the multiple third pictorial characters, each third pictorial character on the third Chinese character tree diagram board is mapped to the pictorial character of one tile in the set of tiles, and the first Chinese character tree diagram board and the second character tree diagram board are associated with each other.

4. The teaching tile set as claimed in claim 1, wherein a first derived link is connected between each two corresponding first pictorial characters on the first Chinese character tree diagram board.

5. The teaching tile set as claimed in claim 2, wherein a second derived link is connected between each two corresponding second pictorial characters on the second Chinese character tree diagram board.

6. The teaching tile set as claimed in claim 3, wherein a third derived link is connected between each two corresponding third pictorial characters on the third Chinese character tree diagram board.

7. The teaching tile set as claimed in claim 1, wherein the first Chinese character tree diagram board is a Chinese character tree diagram board involved with the word, human, in Chinese, which records the first pictorial characters associated with human and the first derived links.

8. The teaching tile set as claimed in claim 2, wherein the second Chinese character tree diagram board is a Chinese character tree diagram board involved with the word, body, in Chinese, which records the second pictorial characters associated with human organs and the second derived links.

9. The teaching tile set as claimed in claim 3, wherein the third Chinese character tree diagram board is not associated with the first Chinese character tree diagram board and the second Chinese character tree diagram board.

10. The teaching tile set as claimed in claim 6, wherein the third Chinese character tree diagram board is not associated with the first Chinese character tree diagram board and the second Chinese character tree diagram board.

11. The teaching tile set as claimed in claim 2, further comprising a third Chinese character tree diagram board, wherein the third Chinese character tree diagram board has a third Chinese character tree diagram with multiple third pictorial characters thereon and multiple derived relationships among the multiple third pictorial characters, each third pictorial character on the third Chinese character tree diagram board is mapped to the pictorial character of one tile in the set of tiles, and the first Chinese character tree diagram board and the second character tree diagram board are associated with each other.

12. The teaching tile set as claimed in claim 11, wherein a third derived link is connected between each two corresponding third pictorial characters on the third Chinese character tree diagram board.

13. The teaching tile set as claimed in claim 12, wherein the third Chinese character tree diagram board is not associated with the first Chinese character tree diagram board and the second Chinese character tree diagram board.

14. The teaching tile set as claimed in claim 11, wherein the third Chinese character tree diagram board is not associated with the first Chinese character tree diagram board and the second Chinese character tree diagram board.

15. The teaching tile set as claimed in claim 4, wherein the first Chinese character tree diagram board is a Chinese character tree diagram board involved with the word, human, in Chinese, which records the first pictorial characters associated with human and the first derived links.

16. The teaching tile set as claimed in claim 5, wherein the second Chinese character tree diagram board is a Chinese character tree diagram board involved with the word, body, in Chinese, which records the second pictorial characters associated with human organs and the second derived links.
